(19) United States
(12) Patent Application Publication
(10) Pub. No.: US 2018/0236726 A1
(43) Pub. Date: Aug. 23, 2018

(54) THREE DIMENSIONAL PRINTING SYSTEM INTEGRATION

(71) Applicant: 3D Systems, Inc., Rock Hill, SC (US)

(72) Inventors: Jamie ETCHESON, San Diego, CA (US); Ben WYNNE, Escondido, GA (US)

(21) Appl. No.: 15/437,960

(22) Filed: Feb. 21, 2017

(51) Int. Cl. B29C 67/00; B33Y 10/00; B33Y 30/00; B33Y 50/02; G05B 19/4099

(52) U.S. Cl. CPC B29C 67/0088; B29C 67/0077; B33Y 10/00; G05B 2219/49007; B33Y 50/02; G05B 19/4099; G05B 2219/35134; B33Y 30/00

(57) ABSTRACT

A three dimensional printing system includes an appliance tier, a processing tier, and a work cell tier. The appliance tier (1) defines a client interface for receiving process parameters and data pipeline parameters for a given production job, and (2) provides instructions based upon the process parameters. The processing tier processes the data pipeline parameters and outputs a sequence of slice data arrays pursuant to a print engine platform. The work cell tier includes a work cell server and a plurality of functional cells. A functional cell can be a print engine, a post processing station, an inspection station, or a robotic transport mechanism. The work cell server transfers the slice data arrays to one or more print engines. Based upon the instructions from the appliance server tier the work cell server sequentially operates the plurality of functional cells to produce a three dimensional article of manufacture.

### FIELD OF THE INVENTION

The present disclosure concerns a three dimensional printing system for the digital fabrication of three dimensional articles. More particularly, the present disclosure concerns an advantageous three dimensional printing system architecture that enables the most productive use of resources and floor space.

### BACKGROUND

Three dimensional printers are in widespread use. There are many technology platforms in use. A technology platform is generally defined by the manner in which a three dimensional printer builds up layers to create a three dimensional article of manufacture. One example of a technology platform is selective laser sintering. Selective laser sintering technology builds up layers of an article by dispensing loose powder layers and then defining individual layers of the article via selective sintering or, melting and solidification of the powder. A second example of a technology platform is stereolithography. Stereolithography technology builds up layers of the article by selectively curing and hardening a photocurable resin. A third example of a technology platform is UV (ultraviolet) inkjet. UV inkjet builds up layers through the selective dispensing and curing of UV curable inks.

Most three dimensional printing systems are utilized for rapid prototyping. Generally speaking most are “stand alone” systems that are computer operated by a personal computer, dedicated terminal, or other client device. This has worked well for prototyping applications. However, there is an increasing desire to utilize three dimensional printing systems for manufacturing. The use of dedicated terminals and printers is very factory labor and floor space intensive. In some applications, 3D printed articles of manufacture may be more expensive than those produced from more conventional processes. There is a need to find more efficient ways of utilizing three dimensional printing systems before they can be utilized to an extensive degree for manufacturing.

### BRIEF DESCRIPTION OF THE FIGURES

FIG. 1 is a schematic block diagram of an exemplary three dimensional printing system.

FIG. 2 is a schematic block diagram depicting an exemplary work cell.

FIG. 3 is a schematic block diagram depicting a print engine.

FIG. 4 is an electrical block diagram depicting a print engine.

FIG. 5 is a flowchart depicting an exemplary process sequence for a three dimensional printing system.

FIG. 6 is a flowchart depicting an exemplary data pipeline for a printing system.

### SUMMARY

In a first aspect of the disclosure, a three dimensional printing system includes an appliance tier, a processing tier, and a work cell tier. The appliance tier (1) defines a client interface for receiving process parameters and data pipeline parameters for a given production job, and (2) provides instructions based upon the process parameters. The processing tier receives and processes the data pipeline parameters and outputs a sequence of slice data arrays pursuant to a print engine platform. The work cell tier includes a work cell server and a plurality of functional cells. A functional cell is one of a print engine, a post processing station, an inspection station, and a transport mechanism. The work cell server transfers the slice data arrays to one or more print engines. Based upon the instructions from the appliance server tier the work cell server sequentially operates the plurality of functional cells to produce a three dimensional article of manufacture.

In one implementation the appliance tier includes a plurality of job handling servers. At least one job handling server can be a back up job handling server that can substitute for a malfunctioning job handling server to minimize a risk of downtime for the three dimensional printing system.

In another implementation the appliance tier generates a plurality of user interfaces on a corresponding plurality of client devices for receiving the production job parameters. A client device can be one or more of a personal computer, a desktop computer, a laptop computer, a tablet computer, and a portable computer to name a few examples.

In yet another implementation the process parameters can include parameters that specify one or more of a material parameter for forming the three dimensional article of manufacture, a process sequence, and an operational parameter for one of the functional cells. A material parameter can be a powder type, a photocurable resin type, a material color, a material property, or a material chemistry, to name some examples. A process sequence concerns the selection of what functional cells are used and in what order. An operational parameter would concern a setting for a given functional cell. Examples of settings include a process time or a process speed to name two examples.

In a further implementation the data pipeline parameters can include a virtual three dimensional body, dimensional factors, a print engine platform, and a slicing thickness, to name some examples. In one embodiment, the virtual three dimensional body is complete in size and proportion and is submitted to the input layer. In another embodiment the virtual three dimensional body is a template and the dimensional factors are used to proportion and size the virtual three dimensional body for slicing. The print engine platform refers to a type of print engine but not necessarily a specific one in the printing system. The appliance tier will limit the slicing thickness to values that are consistent with a selected or available print engine platform.

In a yet further implementation the processing tier includes a plurality of processing node servers which can include a backup processing node server. In one embodiment a processing node server performs the following steps: (1) using a dimensional factor to process a template in order to provide a properly sized and proportioned virtual three dimensional body and (2) process the properly sized and proportioned virtual three dimensional body to provide the sequence of slice data arrays.

In another implementation the work cell tier includes a plurality of work cells. An individual work cell includes a work cell server and a plurality of functional cells. Functional cells can be one of a print engine, a post processing station, an inspection station, and a robotic transport apparatus. A post processing station can be one of a rinse station, a drying station, and a cure station.

In yet another implementation the printing system includes a print engine tier that includes a plurality of print engines. A print engine includes an engine level controller coupled to a light engine and a movement mechanism. The engine level controller includes a system processor coupled to an image scaler. The light engine includes a digital mirror device formatter coupled to a digital mirror device. The image scaler processes the sequence of slice data arrays to provide a sequence of scaled data arrays. Having the image scaler within a print engine allows for corrections that are unique to the particular print engine that don't apply to the remainder of the plurality of print engines. The digital mirror device formatter converts the scaled data arrays into image subframes that can be directly loaded into the digital mirror device.

### DETAILED DESCRIPTION OF THE PREFERRED EMBODIMENTS

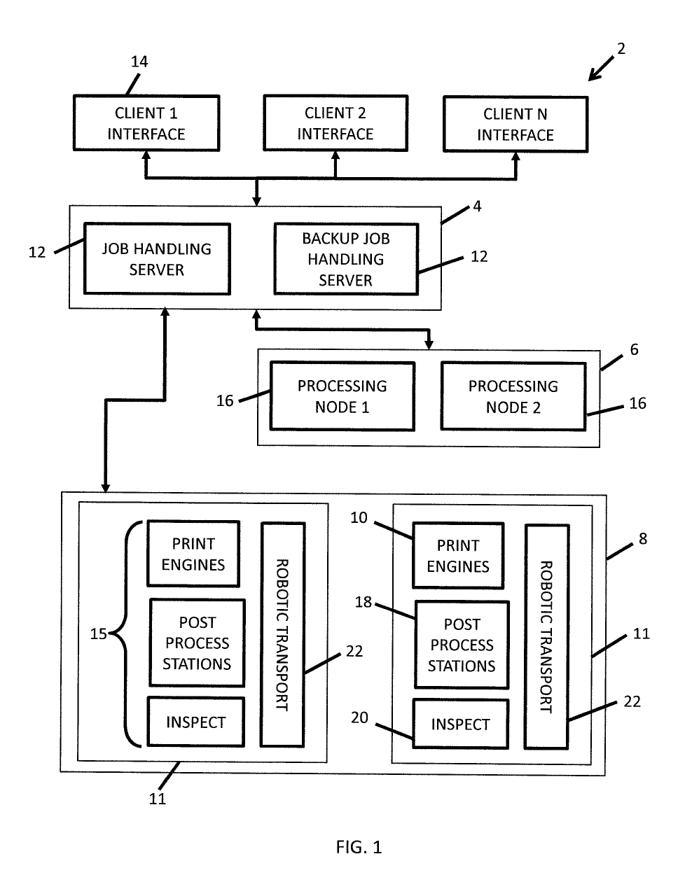

FIG. 1 is a schematic block diagram of a three dimensional printing system 2 that utilizes one or more three dimensional printing platforms. Printing system 2 includes three major tiers including an appliance tier 4, a processing tier 6, and a work cell tier 8. Within the work cell tier 8 are individual work cells 11 and a print engine 10 tier that includes a plurality of individual print engines 10.

The tiers (4, 6, and 8) of three dimensional printing system 2 can be co-located or can be distributed remotely from each other. For example, in some embodiments tiers 4 and 6 can be located in a server facility while tier 8 can be located on a “factory floor.”

Within the appliance tier 4 are a plurality of job handling servers 12. These can include primary and backup job handling servers 12 to enable continuous operation without risk of downtime. The appliance tier 4 has a number of different functions.

A first function of the appliance tier 4 is to provide a plurality of client interfaces 14. Client interfaces 14 may be accessible at nearly any location on any client device such as a personal computer, a laptop computer, or a tablet computer to name a few examples. The client interfaces enable inputting production job parameters. Production job parameters can include data pipeline parameters and process parameters.

Data pipeline parameters relate to the “data pipeline” that defines the geometry of the three dimensional article of manufacture to be fabricated. These parameters can include a virtual three dimensional body, dimensional parameters, a print engine platform, a slicing thickness, and orientation for fabrication. The virtual three dimensional body can be similar to a CAD (computer aided design) representation of the three dimensional article of manufacture. Because a three dimensional print engine 10 produces the article of manufacture in layers, the virtual three dimensional body cannot be directly used by a print engine 10.

Inputting the virtual three dimensional body can be accomplished by directly uploading a three dimensional file to appliance tier 4 using a client interface 14. Alternatively the printing system 2 may store virtual three dimensional bodies that can be selected. In one embodiment these virtual three dimensional bodies are templates for which dimensional parameters can be specified. An example for which this is useful is a body implant. The implant may need to be sized for a particular patient which is accomplished with a set of dimensional parameters input to a client interface 14.

The slicing thickness determines how thick each layer is for the three dimensional article of manufacture. An available slice thickness range will be limited to a particular print engine platform that is either selected or available. Generally speaking, an increased thickness increases manufacturing speed at the expensive of having larger critical dimensions.

Process parameters include material settings, sequence settings and process settings to be used to build the three dimensional article of manufacture. The material setting can be a particular powder or resin to be used. For a multi-material design this may specify certain portions of the virtual three dimensional body to have certain materials. In an exemplary embodiment, a material setting may be a particular type of photocurable resin.

Sequence settings determine which functional cells 15 are used (e.g., post processes or inspections) and the order. Process settings can include robotic transport, post processing, and inspection. Post processing settings can specify the use and duration of processes such as cleaning, drying, and curing after a three dimensional article of manufacture is fabricated. Inspection settings can include a designation of what inspection takes place and what is considered a threshold between an accepted or rejected article.

An additional input to the client interface can be the selection of a “process group.” This input can define at least part of the data pipeline parameter and process parameter data as a single input. The selection of a process group allows the appliance tier 4 to select all functional cells 15 that are defined by the process group.

Another function of the appliance tier 4 is to manage a production queue through the work cell tier 8. When a new production job is being defined, the appliance tier 4 determines which function cells are operational and estimates a schedule for completing the production job. When the production job is submitted by client interface 14, the appliance tier 4 schedules the production job relative to prior production jobs that have been submitted.

The processing tier 6 includes a plurality of processing node servers 16. The processing node servers 16 are used to perform processor intensive operations that prepare virtual three dimensional body data for the print engines 10. When the a virtual three dimensional body template is used, the processing node tier 6 utilizes the input dimensional parameters to scale the virtual three dimensional body. Once a properly scaled virtual three dimensional body data is obtained, then the processing node tier 6 slices the data and provides a series of slice data arrays that can be utilized by the selected print engine platform. The slice data arrays are then transferred to the appliance tier 4 which transfers them to the work cell tier 8 along with instructions. The instructions are based upon the process settings and other factors such as which functional cells are available and prior production jobs that have been submitted.

The work cell tier 8 includes a plurality of work cells 11 each containing a plurality of individual functional cells 15. A functional cell 15 performs a single function and can be a print engine 10, a post process station 18, an inspection station 20, or a robotic transport 22.

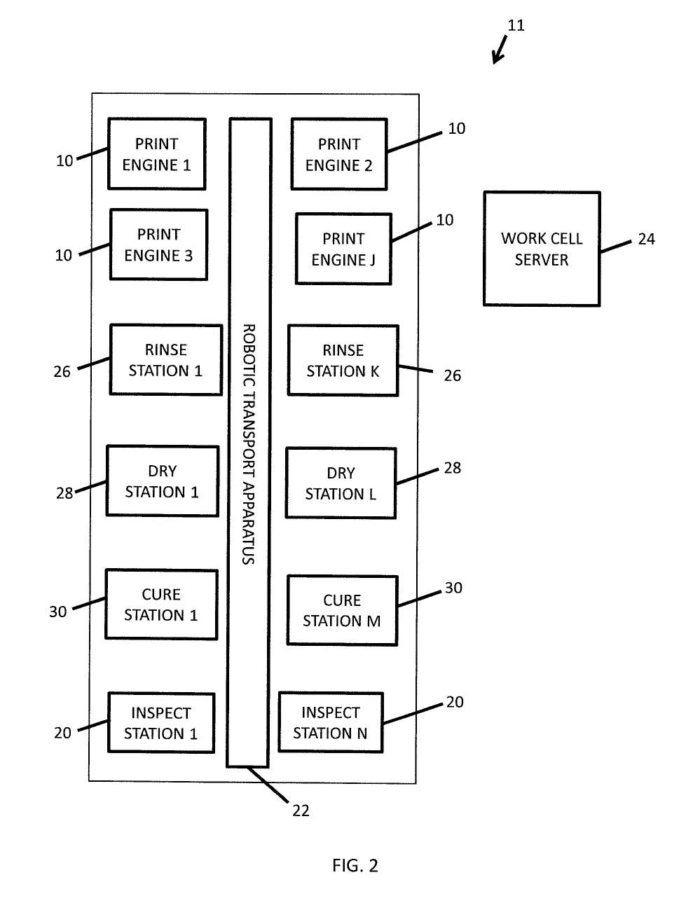

FIG. 2 is a schematic block diagram depicting a single work cell 11. Work cell 11 also includes a work cell server 24 which is coupled to and controls all of the functional cells 15. In an exemplary embodiment the functional cells 15 includes a plurality of stereolithography platform print engines 10. The post process stations 18 include rinse stations 26, dry stations 28, and cure stations 30.

The cell level server 24 receives processed inputs from the appliance tier 4 and the processing tier 6. The work cell server 24 orchestrates the use functional cells 15 based upon the selections input to the appliance tier 4. The cell level server 24 also transfers the series of slice data arrays to each print engine 10 that is specified by the appliance server 4.

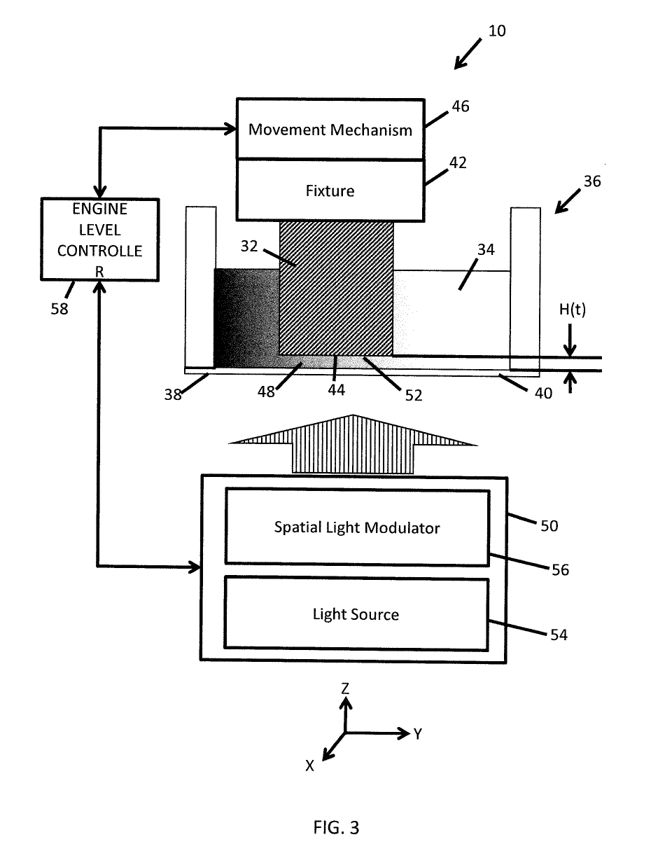

FIG. 3 depicts a schematic block diagram of an exemplary embodiment of print engine 10. The print engine 10 depicted in FIG. 3 generates a three dimensional article of manufacturing 32 through the selective and sequential hardening of layers of a photocure resin 34. In describing print engine 10, mutually perpendicular axes X, Y and Z will be used. Axes X and Y are lateral axes. In some embodiments X and Y are also horizontal axes. Axis Z is a central axis. In some embodiments Z is a vertical axis. In some embodiments the direction +Z is generally upward and the direction −Z is generally downward.

Print engine 10 includes a vessel 36 for containing photocure resin 34 and having a lower portion 38 with a transparent sheet 40. A fixture 42 supports the three dimensional article of manufacturing 32 whereby a lower face 44 of the three dimensional article of manufacturing 32 is in facing relation with the transparent sheet 40. A movement mechanism 46 controls a height H(t) of the lower face 44 above the transparent sheet 40. Between the lower face 44 and the transparent sheet 40 is a thin layer 48 of the photocure resin 34.

A light engine 50 is disposed and configured to project pixelated radiation up through the transparent sheet 40 to selectively illuminate a build plane 52 that is proximate to the lower face 44. Light engine 50 includes a light source 54 that illuminates a spatial light modulator 56. The spatial light modulator 56 includes an array of pixel elements that process “raw” or unprocessed light from the light source 54 to selectively illuminate pixel elements of build plane 52.

An engine level controller 58 is coupled to and controls the movement mechanism 46 and the light engine 50. The engine level controller 58 is further coupled to the work cell server 24 from which it receives commands for controlling the operation of print engine 10. In an alternative embodiment there may be an intermediate computer or controller between work cell server 24 and engine level controller 58.

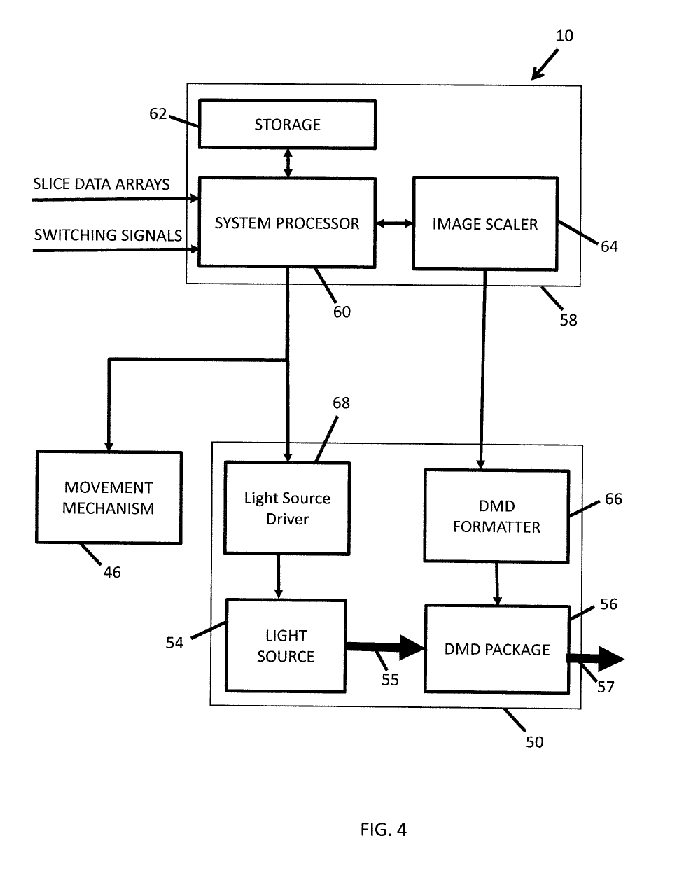

FIG. 4 depicts a simplified electrical block diagram of the print engine 10 from FIG. 3. As with FIG. 3, print engine 10 includes an engine controller 58 coupled to movement mechanism 46 and light engine 50. The engine controller 58 includes a system processor 60 coupled to an information storage device 62. System processor 60 receives slice data arrays and switching (on/off) signals from the work cell server 24. System processor 60 routes signals through print engine 10. The information storage device 62 is for storing a buffer of data to be used by the print engine 10 such as one or more of a sequence of the slice data arrays.

Engine controller 58 also includes an image scaler 64 that processes the slice data arrays to calibrate them, correct them, and scale them to the spatial light modulator 56. The image scaler 64 provides corrections that are specific to the light engine 10 such as keystone and barrel distortion correction. The image scaler 64 also takes the slice data array and scales it to the same pixel element array of the spatial light modulator 56. Finally, the image scaler 64 scales an energy level per pixel and per image frame so that the energy per pixel delivered by light engine 10 is consistent with an incoming slice data array for a given slice to be selectively hardened. The result is a scaled slice data array that is passed from image scaler 64 to the light engine 50.

Light engine 50 includes light source 54, spatial light modulator 56, formatter 66, and light source driver 68. In the illustrated embodiment formatter 66 is a digital mirror device formatter 66 which converts the scaled slice data array into one or more image frames to be passed to spatial light modulator 56. In the illustrated embodiment the spatial light modulator 56 is a digital mirror device (DMD) having an array of a million or more deflectable mirrors. Each deflectable mirror is a pixel element that can be controlled between and on and off state.

The system processor 60 is coupled to the light source driver 68 which provides power to light source 54. In the illustrated embodiment light source 54 is one or more ultraviolet or blue light emitting diodes (LEDs). The system processor turns the light source on and off to control a “bulk” amount of energy delivered to the build plane 52 when a new layer of photocure resin 34 is being hardened onto the lower face 44.

System processor 60 also controls movement mechanism to thereby control the height H(t) of the lower face 44 above the transparent sheet 40. System processor 60 may utilize image scaler 64 to determine or quantify vertical motions of the lower face 44.

Also depicted is raw or unprocessed or bulk light 55 that is emitted by light source 54. The spatial light modulator 56 spatially (and in some cases temporally) processes the raw light 55 to provide spatially modulated light 57.

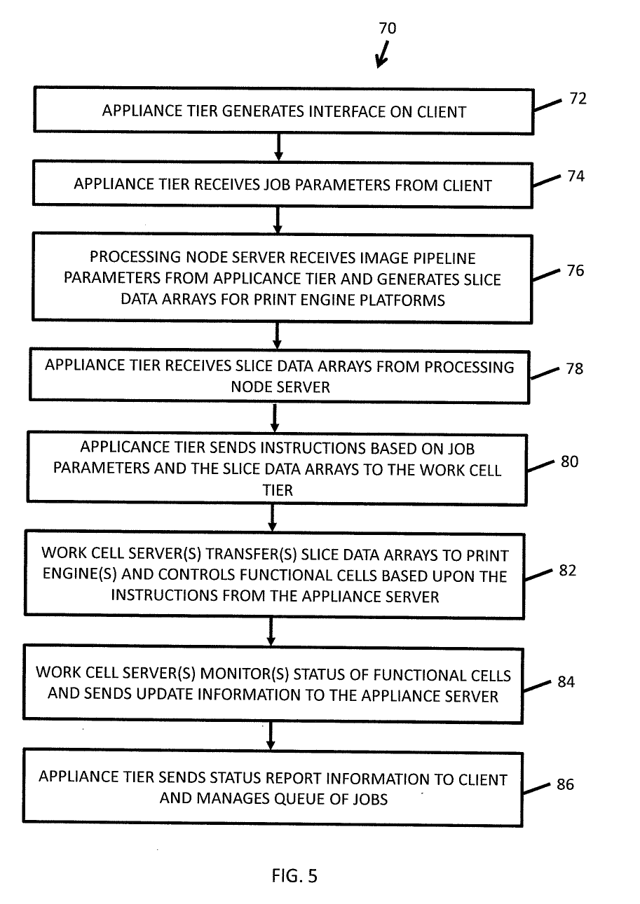

FIG. 5 is a flowchart depicting an exemplary process 70 for printing system 2. The depicted process 70 emphasizes information workflow through the servers of printing system 2.

According to step 72, the appliance tier 4 generates a client interface 14 on a client device. Production job parameters including process parameters and data pipeline parameters are inputted through the client interface 14 which are then received by the appliance server according to step 74.

According to step 76, the appliance tier 4 transfers the data pipeline parameters to the processing tier 6. Also according to step 76, the processing node server 16 receives and processes the data pipeline parameters to define a sequence of slice data arrays that can be utilized by the print engines 10. The slice data arrays are processed to the engine platform level so that they are compatible with the engine platforms being utilized in the work cells 11. Step 76 has two possible embodiments.

In a first embodiment of step 76, processing tier 6 receives a properly proportioned virtual three dimensional body that was submitted to the client interface 14 as part of step 74. The processing tier 6 directly slices the virtual three dimensional body to provide the sequence of slice data arrays.

In a second embodiment of step 76, the processing tier 6 receives or loads a virtual three dimensional body template that was previously stored in the printing system 2. The processing tier 6 utilizes dimensional parameters previously submitted to the client interface 14 to properly proportion and size the virtual three dimensional body template for the production job. Then the processing tier 6 directly slices the properly sized and proportioned virtual three dimensional body to provide the sequence of slice data arrays.

According to step 78, the slice data arrays are transferred from the processing tier 6 to the appliance tier 4. According to step 80, the appliance tier sends instructions and the sequence of slice data arrays to the work cell tier 8. The instructions are based on the process parameters received via the client interface 14. The instructions define sequences of functional cells 15 to be utilized to perform the submitted production job. As part of step 80, the appliance tier identifies available resources (i.e., sets of functional cells 15) that can perform the production job and then schedules the production job relative to pre-existing production jobs.

According to step 82, the individual work cell server(s) 24 operate functional cells 15 pursuant to the instructions received from the appliance tier 4. As part of this operation the work cell servers 24 transfer the sequence of slice data arrays to the appropriate print engines 10.

According to step 84 the work cell server(s) 24 monitor the status of the functional cells 15 and send reporting or update information to the appliance tier 4 that is indicative of the status of the production job.

According to step 86 the appliance tier 4 updates the client interface 14 based upon the production job status. The appliance tier 4 also schedules and tracks a queue containing a plurality of production jobs received from a plurality of clients.

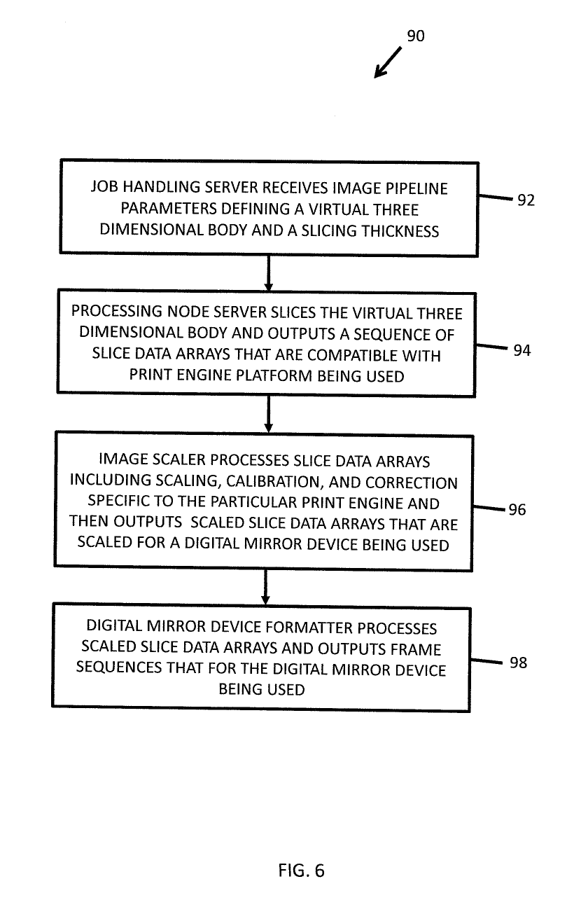

FIG. 6 is a flowchart representing an exemplary data pipeline 90 for printing system 2. According to step 92, a job handling server 12 receives data pipeline parameters that define a virtual three dimensional body and a slicing thickness. The data pipeline parameters are transferred to a processing node server 16.

According to step 94, the processing node server 16 slices the virtual three dimensional body and outputs a sequence of slice data arrays that are compatible with the print engine 10 platform to be used. The sequence of slice data arrays are passed to a print engine 10 via a job handling server 12 and a work cell server 24.

According to step 96, an image scaler 64 processes the slice data arrays including scaling, calibration, and correction. Scaling includes spatial and energy scaling that is specific to the capability of the digital mirror device 56. Correction includes correction of defects that are unique to one light engine 50. Light engines 50 having the same print engine 10 platform may vary due to optical defect variations. The image scaler 64 outputs a sequence of scaled data arrays.

According to step 98, the digital mirror device formatter 66 processes the scaled slice data arrays and outputs image frame sequences. For a given scaled slice data array, one or more image frames are sent from the digital mirror device formatter 66 to the digital mirror device 56.

The specific embodiments and applications thereof described above are for illustrative purposes only and do not preclude modifications and variations encompassed by the scope of the following claims.

What we claim is:

1. A three dimensional printing system which forms three dimensional articles of manufacture through layer-by-layer processes comprising:
an appliance tier that (1) defines a client interface for receiving process parameters and data pipeline parameters for a given production job, and (2) provides instructions based upon the process parameters;
a processing tier that receives and processes the data pipeline parameters and outputs a sequence of slice data arrays pursuant to a print engine platform; and
a work cell tier including a work cell server and a plurality of the functional cells, a functional cell is one of a print engine, a post-processing station, an inspection station, and a robotic transport mechanism, the work cell server transferring the sequence of slice data arrays to a plurality of print engines and utilizes the instructions from the appliance server to sequentially operate the plurality of functional cells to produce a three dimensional article of manufacture.

2. The three dimensional printing system of claim 1 wherein the process parameters include one or more of a material parameter, a process sequence, and an operational parameter.

3. The three dimensional printing system of claim 1 wherein the three dimensional printing system stores a template of a virtual three dimensional body, the data pipeline parameters include dimensional parameters and the processing tier is further configured to (1) use the dimensional factors to process the template in order to provide a properly sized and proportioned virtual three dimensional body and (2) process the properly sized and proportioned virtual three dimensional body to provide the sequence of slice data arrays.

4. The three dimensional printing system of claim 1 wherein the printing system includes a print engine tier that includes a plurality of the print engines, one of the print engines includes an engine level controller that processes the slice data arrays with factors that are different than factors employed by other print engines.

5. The three dimensional printing system of claim 1 wherein the printing system includes a print engine tier that includes a print engine which further includes a movement mechanism, a light engine, and an engine controller that receives print engine instructions and the sequence of slice data arrays from the work cell tier and controls the movement mechanism and the light engine.

6. The three dimensional printing system of claim 5 wherein the engine controller includes a system processor and an image scaler and wherein the system processor transfers the sequence of slice data arrays to the image scaler.

7. The three dimensional printing system of claim 6 wherein the image scaler is coupled to the light engine, the image scaler processes the sequence of slice data arrays to define a sequence of scaled slice data arrays that are scaled for the light engine, the processing by the image scaler including corrections of light engine artifacts and scaling the array of energy values.

8. The three dimensional printing system 7 wherein the light engine includes a digital mirror device formatter and a digital mirror device, the digital mirror device formatter converts a slice data array into one or more image frames that are passed directly to the digital mirror device.

9. The three dimensional printing system of claim 5 wherein the light engine includes a light source driver coupled to a light source, the system processor sends instructions to the light source driver to: (1) turn the light source on for a certain duration to provide a proper amount of light energy for one of the slice data arrays, (2) turn the light source off after providing the proper amount of energy, and (3) activate the movement mechanism to reposition the three dimensional article of manufacture.

10. A method of manufacturing a three dimensional article of manufacture using a three dimensional printing system comprising:
activating an appliance tier to generate a client interface;
receiving at the appliance tier production job parameters including process parameters and data pipeline parameters from the client interface;
transferring the data pipeline parameters to a processing tier;
the processing tier processing the data pipeline parameters to define a sequence of slice data arrays;
the appliance tier generating instructions based upon the process parameters and transferring the instructions and the sequence of slice data arrays to a work cell tier; and
the work cell tier including a plurality of functional cells including a plurality of print engines and a plurality of post-process stations, the work cell tier utilizing the instructions and the sequence of slice data arrays to manufacture a plurality of the three dimensional article of manufacture.

11. The method of manufacturing of claim 10 wherein the data pipeline parameters include a virtual three dimensional body and a slicing thickness.

12. The method of manufacturing of claim 10 wherein the data pipeline parameters include a designation of a virtual three dimensional body template that is stored within the three dimensional printing system and dimensional parameters, the processing tier: (1) utilizing the virtual three dimensional body template and the dimensional parameters to provide a properly sized and proportioned virtual three dimensional body and (2) process the properly sized and proportioned virtual three dimensional body to provide a sequence of slice data arrays.

13. The method of manufacturing of claim 10 wherein one of the print engines includes a movement mechanism, an light engine, and an engine controller that receives print engine instructions and the sequence of slice data arrays from the work cell tier and controls the movement mechanism and the light engine.

14. The method of manufacturing of claim 13 wherein the engine controller includes a system processor and an image scaler and wherein the system processor transfers the sequence of slice data arrays to the image scaler.

15. The method of manufacturing of claim 14 wherein the image scaler is coupled to the light engine, the image scaler processes the sequence of slice data arrays to define a sequence of scaled slice data arrays that scaled for the light engine, the processing by the image scaler including corrections of light engine artifacts and scaling the array of energy values.

16. The method of manufacturing of claim 15 wherein the light engine includes a digital mirror device formatter and a digital mirror device, the digital mirror device formatter converts a sliced data array into one or more image frames that are passed directly to the digital mirror device.

17. The method of manufacturing of claim 13 wherein the light engine includes a light source driver coupled to a light source, the system processor sends instructions to the light source driver to: (1) turn the light source on for a certain duration to provide a proper amount of light energy for one of the slice data arrays, (2) turn the light source off after providing the proper amount of energy, and (3) activate the movement mechanism to position three dimensional article of manufacture.
